(19) United States
(12) Patent Application Publication
(10) Pub. No.: US 2005/0256245 A1
(43) Pub. Date: Nov. 17, 2005

(54) Expandable polystyrene

(75) Inventors: Christian Lechner, Hurlach (DE); Gerd Hohner, Gersthofen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/128,446

(22) Filed: May 13, 2005

(30) Foreign Application Priority Data
May 13, 2004 (DE) 10 2004 023 591.0

(51) Int. Cl. C08F 4/44

(52) U.S. Cl. 524/487

(57) ABSTRACT

The invention relates to expandable polystyrene (EPS) comprising polyolefin waxes, wherein the latter have been prepared by means of metallocene catalysts and have a drop melting point or ring/ball softening point of from 80 to 165° C. and a melt viscosity measured at a temperature which is 10° C. above the drop melting point or softening point of from 20 to 10 000 mPa·s.

The invention relates to expandable polystyrene (EPS) comprising polyolefin waxes which have been prepared by means of metallocene catalysts.

The foam structure is of particular importance in the production of expandable polystyrene. Homogeneity and size of the individual cells determine the foaming properties, i.e. expandability and pressure reduction time, and also the foam properties such as surface quality, mechanical properties (stiffness) and optical properties. As the number of cells increases, i.e. the cells become finer, the demolding times (pressure reduction times) decrease drastically: an increase in the number of cells from 6 to 12 per mm results in an approximate halving of the demolding time. This gives a substantial improvement in the economics of the production process. In addition, finer cell structures result in increased stiffness and a “whiter” appearance.

This desirable, homogeneous and finer cell structure is achieved with the aid of nucleating agents which are added in the polymerization of expandable polystyrene. In the absence of these nucleating agents, cells of different sizes are formed. This has an adverse effect on the above-described mechanical and optical properties of the foam.

Known nucleating agents which can be used are polyethylene or polyolefin waxes, paraffins and Fischer-Tropsch waxes. In general, use is made of unbranched, nonpolar, i.e. unmodified, polyethylene waxes.

The U.S. patents U.S. Pat. No. 3,224,984 and U.S. Pat. No. 3,398,105 describe the use of polyethylene waxes or polyethylene having a molecular weight of from 1000 to 4000 in a concentration of from 0.01 to 0.5%.

U.S. Pat. No. 3,060,138 describes the use of paraffin waxes having chain lengths of from 16 to 46 carbon atoms as nucleating agents for expandable polystyrene.

DE-A-324 38 85 describes the use of linear polyethylene waxes having a molecular weight of from 700 to 1500 g/mol, a melting point of at least 102° C., a density of at least 15.4 g/cm³ and a polydispersity of less than 1.2 (polydispersity=weight average molecular weight divided by number average molecular weight) in concentrations of from 0.05 to 0.5% by weight.

It has now surprisingly been found that polyolefin waxes prepared by means of metallocene catalysts are particularly advantageous as nucleating agents for EPS. In particular, it has been found that expandable polystyrene comprising metallocene wax has excellent positive properties in respect of the fineness and homogeneity of the cell structure of expandable polystyrene. The cell count per defined area of expandable polystyrene compared to nucleating agents which are conventionally used is significantly increased by the use of polyolefin waxes prepared by means of metallocene catalysis, which is reflected in better mechanical properties (stiffness, reduced indentation susceptibility) of the foam, “whiter” appearance and significantly accelerated pressure decrease, i.e. increased demolding rate. Furthermore, the cell size is regulated so that homogeneous cells without significant size differences between them are formed.

The invention accordingly provides expandable polystyrene comprising polyolefin waxes, wherein the latter have been prepared by means of metallocene catalysts and have a drop melting point or ring/ball softening point of from 80 to 165° C. and a melt viscosity measured at a temperature which is 10° C. above the drop melting point or softening point of from 20 to 10 000 mPa·s.

Here, the melt viscosities were determined in accordance with DIN 53019 using a rotational viscometer, the drop melting points were determined in accordance with DIN 51801/2 and the ring/ball softening points were determined in accordance with DIN EN 1427.

The polyolefin waxes preferably have a drop melting point or ring/ball softening point of from 90 to 160° C. and a melt viscosity measured at a temperature which is 10° C. above the drop melting point or softening point of from 30 to 8000 mPa·s.

The polyolefin waxes preferably have a weight average molar mass Mw of from 1000 to 30 000 g/mol and a number average molar mass Mn of from 500 to 20 000 g/mol.

The polyolefin waxes particularly preferably have a weight average molar mass M_{w} of from 2000 to 10 000 and a number average molar mass of from 800 to 3000.

Preference is given to ethylene homopolymer waxes being present as polyolefin waxes.

Preference is given to copolymer waxes comprising ethylene and from 0.1 to 30% by weight of at least one branched or unbranched 1-alkene having from 3 to 20 carbon atoms being present as polyolefin waxes.

Preference is also given to propylene homopolymer waxes being present as polyolefin waxes.

Preference is given to copolymer waxes comprising propylene and from 0.1 to 30% by weight of ethylene and/or at least one branched or unbranched 1-alkene having from 4 to 20 carbon atoms being present as polyolefin waxes.

Furthermore, fillers or auxiliaries such as blowing agents, pigments and antioxidants and also light stabilizers, flame retardants or antistatics are preferably present.

Possible polyolefin waxes are homopolymers of ethylene or higher 1-olefins or copolymers of these. As 1-olefins, preference is given to using linear or branched olefins having from 3 to 18 carbon atoms, preferably from 3 to 6 carbon atoms. These olefins can have an aromatic substituent conjugated with the olefinic double bond. Examples are propene, 1-butene, 1-hexene, 1-octene or 1-octadecene and also styrene. Preference is given to homopolymers of ethylene or propene or copolymers of these. The copolymers preferably comprise from 70 to 99.9% by weight, preferably from 80 to 99% by weight, of one type of olefin.

Olefin homopolymer and copolymer waxes having a weight average molar mass M_{w} of from 1000 to 30 000 g/mol, preferably from 2000 to 10 000 g/mol, a number average molar mass Mₙ of from 500 to 20 000 g/mol, preferably from 800 to 3000 g/mol, a drop melting point or ring/ball softening point of from 80 to 165° C., preferably from 90 to 160° C., and a melt viscosity measured at a temperature which is 10° C. above the drop melting point or softening point of from 20 to 10 000 mPa·s, preferably from 30 to 8000 mPa·s, are suitable.

The expandable polystyrene of the invention can further comprise fillers or auxiliaries such as pigments, blowing agents and antioxidants and also further polymer additives such as flame retardants, antistatics and light stabilizers.

The polyolefin waxes used according to the invention are prepared using metallocene compounds of the formula I. 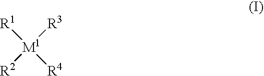
This formula also encompasses compounds of the formula Ia, 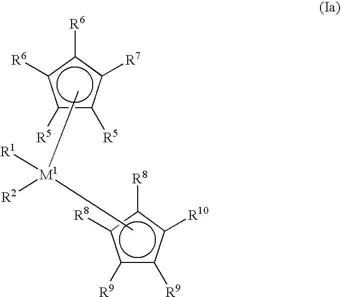
the formula Ib 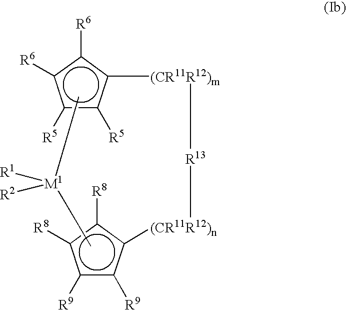
and the formula Ic

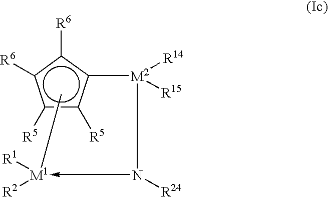

In the formulae I, Ia and Ib, M¹ is a metal of group IVb, Vb or VIb of the Periodic Table, for example titanium, zirconium, hafnium, vanadium, niobium, tantalum, chromium, molybdenum, tungsten, preferably titanium, zirconium, hafnium.

R¹ and R² are identical or different and are each a hydrogen atom, a C₁-C₁₀, preferably C₁-C₃-alkyl group, in particular methyl, a C₁-C₁₀-, preferably C₁-C₃-alkoxy group, a C₆-C₁₀, preferably C₆-C₈-aryl group, a C₆-C₁₀-, preferably C₆-C₈-aryloxy group, a C₂-C₁₀, preferably C₂-C₄-alkenyl group, a C₇-C₄₀-, preferably C₇-C₁₀-arylalkyl group, a C₇-C₄₀-, preferably C₇-C₁₂-alkylaryl group, a C₈-C₄₀-, preferably C₈-C₁₂-arylalkenyl group or a halogen atom, preferably a chlorine atom.

R³ and R⁴ are identical or different and are each a monocyclic or polycyclic hydrocarbon radical which can form a sandwich structure with the central atom M¹. R³ and R⁴ are preferably cyclopentadienyl, indenyl, tetrahydroindenyl, benzindenyl or fluorenyl, with the basic skeletons also being able to bear additional substituents or being bridged to one another. In addition, one of the radicals R³ and R⁴ can be a substituted nitrogen atom, with R²⁴ having the meanings of R¹⁷ and preferably being methyl, tert-butyl or cyclohexyl.

R⁵, R⁶, R⁷, R⁸, R⁹ and R¹⁰ are identical or different and are each a hydrogen atom, a halogen atom, preferably a fluorine, chlorine or bromine atom, a C₁-C₁₀-, preferably C₁-C₄-alkyl group, a C₆-C₁₀-, preferably C₆-C₈-aryl group, a C₁-C₁₀-, preferably C₁-C₃-alkoxy group, a —NR¹⁶₂—, —SR¹⁶—, —OSiR¹⁶₃—, —SiR¹⁶₃— or —PR¹⁶₂— radical, where R¹⁶ is a C₁-C₁₀-, preferably C₁-C₃-alkyl group or C₆-C₁₀-, preferably C₆-C₈-aryl group or in the case of Si- or P-containing radicals may also be a halogen atom, preferably a chlorine atom, or two adjacent radicals R⁵, R⁶, R⁷, R⁸, R⁹ or R¹⁰ at a time together with the carbon atoms connecting them form a ring. Particularly preferred ligands are the substituted compounds derived from the basic skeletons cyclopentadienyl, indenyl, tetrahydroindenyl, benzindenyl and fluorenyl.

R¹³ is 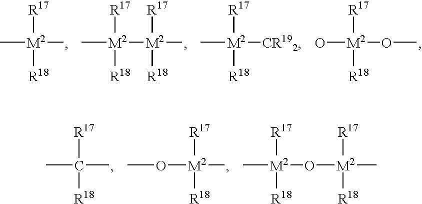
═BR¹⁷, ═AlR¹⁷, —Ge—, —Sn—, —O—, —S—, ═SO, ═SO₂, ═NR¹⁷, ═CO, ═PR¹⁷ or ═P(O)R¹⁷, where R¹⁷, R¹⁸ and R¹⁹ are identical or different and are each a hydrogen atom, a halogen atom, preferably a fluorine, chlorine or bromine atom, a C₁-C₃₀-, preferably C₁-C₄-alkyl group, in particular a methyl group, a C₁-C₁₀-fluoroalkyl group, preferably a CF₃ group, a C₆-C₁₀-fluoraryl group, preferably a pentafluorophenyl group, a C₆-C₁₀-, preferably C₆-C₈-aryl group, a C₁-C₁₀-, preferably C₁-C₄-alkoxy group, in particular a methoxy group, a C₂-C₁₀, preferably C₂-C₄-alkenyl group, a C₇-C₄₀-, preferably C₇-C₁₀-aralkyl group, a C₈-C₄₀-, preferably C₈-C₁₂-arylalkenyl group or a C₇-C₄₀, preferably C₇-C₁₂-alkylaryl group, or R¹⁷ and R¹⁸ or R¹⁷ and R¹⁹ in each case together with the atoms connecting them form a ring.

M² is silicon, germanium or tin, preferably silicon or germanium. R¹³ is preferably ═CR⁷R¹⁸, ═SiR⁷R¹⁸, ═GeR¹⁷R¹⁸, —O—, —S—, ═SO, ═PR or ═P(O)R¹⁷.

R¹¹ and R¹² are identical or different and have the meanings given for R¹⁷. m and n are identical or different and are each zero, 1 or 2, preferably zero or 1, with m plus n being zero, 1 or 2, preferably zero or 1.

R¹⁴ and R¹⁵ have the meanings of R¹⁷ and R¹⁸.

Examples of suitable metallocenes are:
bis(1,2,3-trimethylcyclopentadienyl)zirconium dichloride,
bis(1,2,4-trimethylcyclopentadienyl)zirconium dichloride,
bis(1,2-dimethylcyclopentadienyl)zirconium dichloride,
bis(1,3-dimethylcyclopentadienyl)zirconium dichloride,
bis(1-methylindenyl)zirconium dichloride,
bis(1-n-butyl-3-methylcyclopentadienyl)zirconium dichloride,
bis(2-methyl-4,6-di-i-propylindenyl)zirconium dichloride,
bis(2-methylindenyl)zirconium dichloride,
bis(4-methylindenyl)zirconium dichloride,
bis(5-methylindenyl)zirconium dichloride,
bis(alkylcyclopentadienyl)zirconium dichloride,
bis(alkylindenyl)zirconium dichloride,
bis(cyclopentadienyl)zirconium dichloride,
bis(indenyl)zirconium dichloride,
bis(methylcyclopentadienyl)zirconium dichloride,
bis(n-butylcyclopentadienyl)zirconium dichloride,
bis(octadecylcyclopentadienyl)zirconium dichloride,
bis(pentamethylcyclopentadienyl)zirconium dichloride,
bis(trimethylsilylcyclopentadienyl)zirconium dichloride,
biscyclopentadienylzirconium dibenzyl,
biscyclopentadienylzirconium dimethyl,
bistetrahydroindenylzirconium dichloride,
dimethylsilyl-9-fluorenylcyclopentadienylzirconium dichloride,
dimethylsilylbis-1-(2,3,5-trimethylcyclopentadienyl)zirconium dichloride,
dimethylsilylbis-1-(2,4-dimethylcyclopentadienyl)zirconium dichloride,
dimethylsilylbis-1-(2-methyl-4,5-benzindenyl)zirconium dichloride,
dimethylsilylbis-1-(2-methyl-4-ethylindenyl)zirconium dichloride,
dimethylsilylbis-1-(2-methyl-4-i-propylindenyl)zirconium dichloride,
dimethylsilylbis-1-(2-methyl-4-phenylindenyl)zirconium dichloride,
dimethylsilylbis-1-(2-methylindenyl)zirconium dichloride,
dimethylsilylbis-1-(2-methyltetrahydroindenyl)zirconium dichloride,
dimethylsilylbis-1-indenylzirconium dichloride,
dimethylsilylbis-1-indenyldimethylzirconium,
dimethylsilylbis-1-tetrahydroindenylzirconium dichloride,
diphenylmethylene-9-fluorenylcyclopentadienylzirconium dichloride,
diphenylsilylbis-1-indenylzirconium dichloride,
ethylenebis-1-(2-methyl-4,5-benzindenyl)zirconium dichloride,
ethylenebis-1-(2-methyl-4-phenylindenyl)zirconium dichloride,
ethylenebis-1-(2-methyltetrahydroindenyl)zirconium dichloride,
ethylenebis-1-(4,7-dimethylindenyl)zirconium dichloride,
ethylenebis-1-indenylzirconium dichloride,
ethylenebis-1-tetrahydroindenylzirconium dichloride,
indenylcyclopentadienylzirconium dichloride
isopropylidene(1-indenyl)(cyclopentadienyl)zirconium dichloride,
isopropylidene(9-fluorenyl)(cyclopentadienyl)zirconium dichloride,
phenylmethylsilylbis-1-(2-methylindenyl)zirconium dichloride,
and also the alkyl or aryl derivatives of each of these metallocene dichlorides.

To activate the single-site catalyst systems, suitable cocatalysts are employed. Cocatalysts suitable for metallocenes of the formula I are organoaluminum compounds, in particular aluminoxanes, and also aluminum-free systems such as R²⁰ₓNH₄₋ₓBR²¹₄, R²¹₄₋ₓPH₄₋ₓBR²¹₄, R²⁰₃CBR²¹₄ or BR²¹₃. In these formulae, x is from 1 to 4, the radicals R²⁰ are identical or different, preferably identical, and are each C₁-C₁₀-alkyl or C₆-C₁₈-aryl or two radicals R²⁰ together with the atoms connecting them form a ring, and the radicals R²′ are identical or different, preferably identical, and are each C₆-C₁₈-aryl, which may be substituted by alkyl, haloalkyl or fluorine. In particular, R²⁰ is ethyl, propyl, butyl or phenyl and R²¹ is phenyl, pentafluorophenyl, 3,5-bistrifluoromethylphenyl, mesityl, xylyl or tolyl.

In addition, a third component is frequently necessary to maintain protection against polar catalyst poisons. Organoaluminum compounds such as triethylaluminum, tributylaluminum and others and also mixtures are suitable for this purpose.

Depending on the process, it is also possible to employ supported single-site catalysts. Preference is given to catalyst systems in which the residual contents of support material and cocatalyst do not exceed a concentration of 100 ppm in the product.

The preparation of such polyolefin waxes is described, for example, in the documents EP-A-0 321 851, EP-A-0 321 852 and EP-A-0 384 264.

The polyolefin waxes are present in the expandable polystyrene in a proportion by weight of from 0.01 to 10%, preferably from 0.03 to 5%.

### EXAMPLES

Use Test Results

To carry out the suspension polymerization, water (deionized), DMS (dimeric

α-methylstyrene) as suspension aid and the wax to be tested were placed in a steel vessel. Styrene and initiator (peroxide) were subsequently metered in. After stirring for two hours, the mixture was heated to 100° C. and the temperature was maintained for 5.5 hours. The temperature is then increased to 130° C. and maintained for 2 hours. After cooling to about 80-85° C., firstly suspension stabilizer and then n-pentane are metered in over 1.5 hours.

The beads obtained were centrifuged off and dried and cooled by means of air, coated with EBS (bisstearoylethylenediamine) as anticaking agent and a bead size fraction of 1-2 mm was sieved out. This was prefoamed batchwise at atmospheric pressure and subsequently foamed to give a cuboid by means of a steam pressure of 1.2 bar. The pressure reduction, i.e. the time required for demolding, was determined and the cell count per mm was determined by examination of a cut surface under the microscope. The foam structure was also judged visually and an assessment was made of the homogeneity (equal cell sizes) or inhomogeneity (cells of different sizes) of the cell structure. In particular, small uniform cells give a white appearance of the cut surface, while different cell sizes produce a grayish appearance.

The molar masses M_{w} and Mₙ of the waxes used were determined by gel permeation chromatography at 135° C. in 1,2-dichlorobenzene.

### EXAMPLES

### Example 1 (Comparative Example)

The above-described reaction was carried out without addition of a wax.

### Example 2

The reaction was carried out using 0.1% by weight of a metallocene polyethylene wax (homopolymer) from Clariant, trade name TP Licocene® PE 4201 (Mₙ=1200 g/mol, M_{w}=2400 g/mol, drop melting point=123° C., viscosity at 140° C.=60 mPa·s).

### Example 3

The reaction was carried out using 0.1% by weight of a metallocene polyethylene wax (copolymer containing 5% by weight of propene) (Mₙ=2300 g/mol, M_{w}=5100 g/mol, drop melting point=118° C., viscosity at 140° C.=900 mPa·s).

### Example 4

The reaction was carried out using 0.1% of a Ziegler polyethylene wax (Mₙ=1600 g/mol, M_{w}=4800 g/mol, drop melting point=130° C., viscosity at 140° C.=550 mPa·s).

### Example 5

The reaction was carried out using 0.1% of a polyethylene wax which had been prepared by the high-pressure process (Mₙ=1500 g/mol, M_{w}=3500 g/mol, drop melting point=110° C., viscosity at 140° C.=7 00 mPa·s).

### Example 6

The reaction was carried out using 0.1% of a high molecular weight Ziegler polyethylene wax (Mₙ=5500 g/mol, M_{w}=18000 g/mol, drop melting point=135° C., viscosity at 140° C.=23000 mPa·s).

Evaluation:

| | | Demolding | |
|---|---|---|---|
| Example | Cell count/mm⁻¹ | time [s] | Foam structure |
| 1 (comp.) | 6 | 490 | inhomogeneous, “gray” |
| 2 | 15 | 110 | homogeneous, pure white |
| 3 | 13 | 120 | homogeneous, pure white |
| 4 (comp.) | 10 | 150 | homogeneous, white |
| 5 (comp.) | 8 | 230 | inhomogeneous, “gray” |
| 6 (comp.) | 7 | 270 | Inhomogeneous, “gray” |

As can be seen from the table, the use of waxes prepared by means of metallocene catalysts leads to comparatively high cell counts, reduced demolding times and a more advantageous foam structure.

1. An expandable polystyrene comprising from 0.01 to 10% by weight of at least one polyolefin wax, wherein the at least one polyolefin is prepared using at least one metallocene catalyst and has a drop melting point or ring/ball softening point of from 80 to 165° C. and a melt viscosity measured at a temperature which is 10° C. above the drop melting point or softening point of from 20 to 10 000 mPa·s.

2. The expandable polystyrene as claimed in claim 1, wherein the at least one polyolefin wax has a drop melting point or ring/ball softening point of from 90 to 160° C. and a melt viscosity measured at a temperature which is 10° C. above the drop melting point or softening point of from 30 to 8000 mPa.

3. The expandable polystyrene as claimed in claim 1, wherein the at least one polyolefin wax has a weight average molar mass M_{w} of from 1000 to 30 000 g/mol and a number average molar mass Mₙ of from 500 to 20 000 g/mol.

4. The expandable polystyrene as claimed in claim 1, wherein the at least one polyolefin wax has a weight average molar mass M_{w} of from 2000 to 10 000 g/mol and a number average molar mass Mₙ of from 800 to 3000 g/mol.

5. The expandable polystyrene as claimed in claim 1, wherein the at least one polyolefin wax is an ethylene homopolymer wax.

6. The expandable polystyrene as claimed in claim 1, wherein the at least one polyolefin wax is a copolymer wax comprising ethylene and from 0.1 to 30% by weight of at least one branched or unbranched 1-alkene having from 3 to 20 carbon atoms.

7. The expandable polystyrene as claimed in claim 1, wherein the at least one polyolefin wax is a propylene homopolymer wax.

8. The expandable polystyrene as claimed in claim 1, wherein the at least one polyolefin wax is a copolymer wax comprising propylene and from 0.1 to 30% by weight of at least one of ethylene and at least one branched or unbranched 1-alkene having from 4 to 20 carbon atoms.

9. The expandable polystyrene as claimed in claim 1, further comprising at least one filler or auxiliary.

10. The expandable polystyrene as claimed in claim 8, wherein the at least one filler or auxiliary is selected from the group consisting of blowing agents, pigments, antioxidants, light stabilizers, flame retardants and antistatics.

11. A molded article comprising the expandable polystyrene as claimed in claim 1.
